(19) United States
(12) Patent Application Publication
(10) Pub. No.: US 2017/0255489 A1
(43) Pub. Date: Sep. 7, 2017

(54) DISTRIBUTED TASK PROCESSING WITHIN PHYSICAL ENVIRONMENT BASED ON MOBILE DEVICE USER CAPACITY

(71) Applicant: United Parcel Service of America, Inc., Atlanta, GA (US)

(72) Inventors: Ted Abebe, Jersey City, NJ (US); Jonathan C. Gray, Bridgewater, NJ (US); Richard Allen Kerslake, Norwood, NJ (US); Timothy D. Karnes, East Brunswick, NJ (US); Edward J. Nadrotowicz, JR., Monroe, NY (US); Lawrence A. Lagrosa, Piscataway, NJ (US); Joseph S. Rizzo, JR., Woodstock, GA (US); Scott Alan Loverich, Westwood, NJ (US)

(21) Appl. No.: 15/446,311

(22) Filed: Mar. 1, 2017

Related U.S. Application Data
(60) Provisional application No. 62/302,402, filed on Mar. 2, 2016.
(60) Provisional application No. 62/359,541, filed on Jul. 7, 2016.

(51) Int. Cl. G06F 9/48; G06F 9/50

(52) U.S. Cl. CPC G06F 9/4887; G06F 9/5055

(57) ABSTRACT

Various embodiments are directed to a distributed computing task processor comprising a central computing entity and one or more mobile computing entities. The central computing entity is configured to generate task records corresponding to one or more tasks and to delegate various tasks to the one or more mobile computing entities. The mobile computing entities, in turn, are configured to complete the assigned tasks by retrieving data from various locations within a physical environment and/or by generating data locally on the mobile computing entity to be included in the task record to complete the task. The mobile computing entities may be configured to transmit the updated task records to the central computing entity for storage.

### CROSS-REFERENCE TO RELATED APPLICATIONS

This patent application claims priority from Provisional Application Ser. No. 62/302,402, filed Mar. 2, 2016 and from Provisional Application Ser. No. 62/359,541, filed Jul. 7, 2017, each of which are incorporated herein by reference in their entirety.

### BACKGROUND

Certain computer-based processes, such as monitoring the completion of various physical tasks has historically suffered from inaccurate and/or imprecise data logging. Because various existing task monitoring systems utilize user input when determining whether a task has been begun or completed, the accuracy of such task monitoring systems are generally hindered by user input errors (e.g., unintentional data input errors and/or intentional data input errors). Such errors may lead to incorrect determinations regarding the amount of time and/or resources required for completing various tasks, and may ultimately cause the creation of incorrect time and/or resource expectations for completing various tasks.

Accordingly, a need exists for task monitoring systems that minimize the likelihood of user input errors.

### BRIEF SUMMARY

Various embodiments are directed to distributed task management systems comprising a central computing entity for storing data indicative of the completion and/or scheduling of various tasks, and for delegating those tasks to various mobile devices for completion within a physical environment. The mobile devices are configured to generate data to complete the various delegated tasks, and to transmit the generated data to the central computing entity for storage and use in updating task schedules for future delegation.

Various embodiments are directed to a distributed computing task processor comprising a central computing entity and one or more mobile computing entities. In certain embodiments, the central computing entity is configured to: generate one or more task records corresponding to one or more computing tasks, wherein each task record identifies one or more data types to be provided to complete the computing task; and delegate the one or more computing tasks to one or more mobile computing entities in electronic communication with the central computing entity. The one or more mobile computing entities may be configured to: receive one or more task records corresponding to computing tasks delegated to the mobile computing entity; retrieve, from external data sources, external task data identified by the task record; generate local task data identified by the task record; update one or more task records to include at least a portion of the external task data and the local task data to complete at least a portion of the task; and transmit at least a portion of the one or more updated task records to the central computing entity.

In various embodiments, the central computing entity is configured to generate one or more task records based at least in part on an existing task record stored in association with the central computing entity and a task generation criteria (e.g., specifying a task generation frequency for a particular task type). Moreover, in various embodiments, the one or more mobile computing entities are selectably associated with a user profile, and accordingly delegating the one or more computing tasks comprises delegating the one or more computing tasks to a user profile.

In certain embodiments, delegating one or more computing tasks comprises: determining an estimated resource intensity for each of one or more computing tasks; determining a resource availability for each of one or more mobile computing entities; delegating one or more tasks to one or more mobile computing entities such that the overall estimated resource intensity of tasks delegated to a particular mobile computing entity is equal to or less than the resource availability for the mobile computing entity. In certain embodiments, the estimated resource intensity for a task is the estimated amount of time to complete the task; and the resource availability for a mobile computing entity is the amount of time available for the mobile computing entity to complete one or more tasks.

In various embodiments, retrieving external task data comprises scanning an external data source. In certain embodiments, scanning an external data source comprises wirelessly retrieving data from an external data source emitter. Moreover, generating local task data may comprise generating location data indicative of a current location of the mobile computing entity and/or generating local task data comprises generating time data indicative of a current time. Moreover, in certain embodiments, the central computing entity is further configured to: store at least a portion of the updated task records; and generate one or more graphical user interfaces providing a graphical display of at least a portion of the updated task records.

Various embodiments are directed to a method for processing one or more computing tasks. In certain embodiments, the method comprising steps for: generating, via a central computing entity, one or more task records corresponding to one or more computing tasks, wherein each task record identifies one or more data types to be provided to complete the computing task; delegating, via the central computing entity, the one or more computing tasks to one or more mobile computing entities in electronic communication with the central computing entity; retrieving, via a mobile computing entity and from external data sources, from external data sources, external task data identified by the task record; generating, via the mobile computing entity, local task data identified by the task record; and updating, via the mobile computing entity, one or more task records to include at least a portion of the external task data and the local task data to complete at least a portion of the task.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a distributed system according to various embodiments;

FIG. 2 shows a schematic diagram of a central computing entity according to various embodiments;

FIG. 3 shows a schematic diagram of a mobile computing entity according to various embodiments; and

FIGS. 4-6 are flowcharts showing example processes performed by various aspects of the distributed system according to various embodiments.

### DETAILED DESCRIPTION

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

Overview

Various embodiments are directed to distributed systems for scheduling, delegating, and/or completing various computer-based tasks, comprising a central computing entity for scheduling and/or delegating various tasks, and one or more mobile computing entities for completing various tasks based on interactions with a surrounding physical environment. Thus, the mobile computing entities may move independently throughout a physical environment and generate data to complete assigned tasks.

For example, a distributed system according to various embodiments may be utilized to monitor the completion of various fleet-appearance management jobs to be performed by various individuals. In such an embodiment, the central computing entity may delegate various computing tasks to mobile computing entities carried by the various individuals, each task corresponding to a job to be completed by the individual. As the individual completes the various assigned jobs (e.g., refuel vehicles, wash vehicles, sweep vehicles, check fluids in vehicles, and/or the like), the mobile computing entity (e.g., actively and/or passively) one or more activity tags indicative of a user task performed by the individual using the mobile computing entity. In turn, the mobile computing entity may generate data to complete a computing task corresponding to the user task. For example, the mobile computing entity may generate data indicative of the one or more activity tags scanned (e.g., a vehicle tag scanned, a tag corresponding to a particular activity scanned, and/or the like), time data indicative of when the activity tags are scanned, location data indicative of the determined location of the mobile computing entity when the activity tags are scanned, and/or the like. As a specific example, when an individual refuels a particular vehicle, the individual may utilize the mobile computing entity to scan an activity tag on the vehicle indicative of the identity of the vehicle and an activity tag on a fuel pump used to refuel the vehicle. The mobile computing entity may thereby generate data indicative of the identity of the vehicle, the identity of the fuel pump, the location of the mobile computing entity when the vehicle and/or the fuel pump activity tags are scanned, and the time the activity tags are scanned. In various embodiments, the mobile computing entity may be configured to generate supplemental data regarding various tasks based on user input received by the mobile computing entity (e.g., user input indicative of an amount of fuel added during a refueling task).

In various embodiments, the mobile computing entity may generate data indicative of a time one or more activity tags are scanned to indicate an activity has begun and may generate data indicative of a time one or more activity tags are scanned to indicate an activity has ended. Thus, the mobile computing entity may monitor the amount of time needed to complete various tasks.

The one or more mobile computing entities may be configured to transmit at least a portion of the generated data to the central computing entity. The central computing entity may be configured to update a stored task schedule based on data indicating various tasks have been completed, and to update future task delegation rules based on determined amounts of time and/or resources needed to complete various tasks. For example, the amount of time needed to complete various tasks may be based on an average of prior times needed to complete the same task. Thus, the average time to complete the task may be updated each time the task is completed.

In various embodiments, the central computing entity may be configured to generate one or more graphical displays indicative of various task schedules and/or completed tasks. For example, the central computing entity may monitor the identity of an individual associated with various completed tasks, and may generate various displays indicative of user activities. The central computing entity may generate Gantt charts, efficiency analysis outputs, activity completion dashboards, and/or the like.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

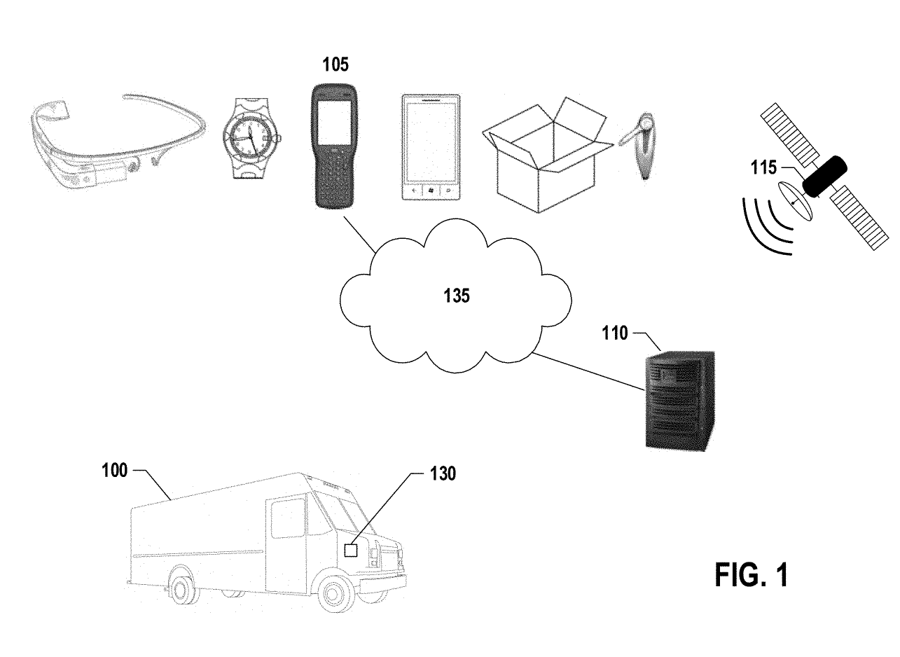

FIG. 1 provides an illustration of a system that can be used in conjunction with various embodiments of the present invention. As shown in FIG. 1, the system may include one or more vehicles 100, one or more mobile computing entities 105, one or more central computing entities 110, one or more Global Positioning System (GPS) satellites 115, one or more user computing entities 140 (not shown), and/or the like. Various components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain system entities as separate, standalone entities, the various embodiments are not limited to this particular architecture.

a. Exemplary Vehicle

In various embodiments, the term vehicle 100 is used generically. For example, a vehicle 100 may be a manned or an unmanned tractor, truck, car, motorcycle, moped, Segway, bicycle, golf cart, hand truck, cart, trailer, tractor and trailer combination, van, flatbed truck, vehicle, drone, airplane, helicopter, boat, barge, and/or any other form of object for moving or transporting people and/or items (e.g., one or more packages, parcels, bags, containers, loads, crates, items banded together, vehicle parts, pallets, drums, the like, and/or similar words used herein interchangeably). In one embodiment, each vehicle 100 may be associated with a unique vehicle identifier (such as a vehicle ID) that uniquely identifies the vehicle 100. The unique vehicle ID (e.g., trailer ID, tractor ID, vehicle ID, and/or the like) may include characters, such as numbers, letters, symbols, and/or the like. For example, an alphanumeric vehicle ID (e.g., “AS445”) may be associated with each vehicle 100. In another embodiment, the unique vehicle ID may be the license plate, registration number, or other identifying information/data assigned to the vehicle 100. In various embodiments, the unique vehicle ID may be stored in a vehicle identifier tag 130 that may be scannable by, for example, a mobile computing entity. As discussed herein, the vehicle identifier tag may comprise a bar code, QR code, Maxicode, alphanumeric string, active and/or passive Radio Frequency Identifier (RFID) tag, Bluetooth Low Energy (BLE) beacon, and/or the like that may be scanned by a mobile computing entity 105.

b. Exemplary Central Computing Entity

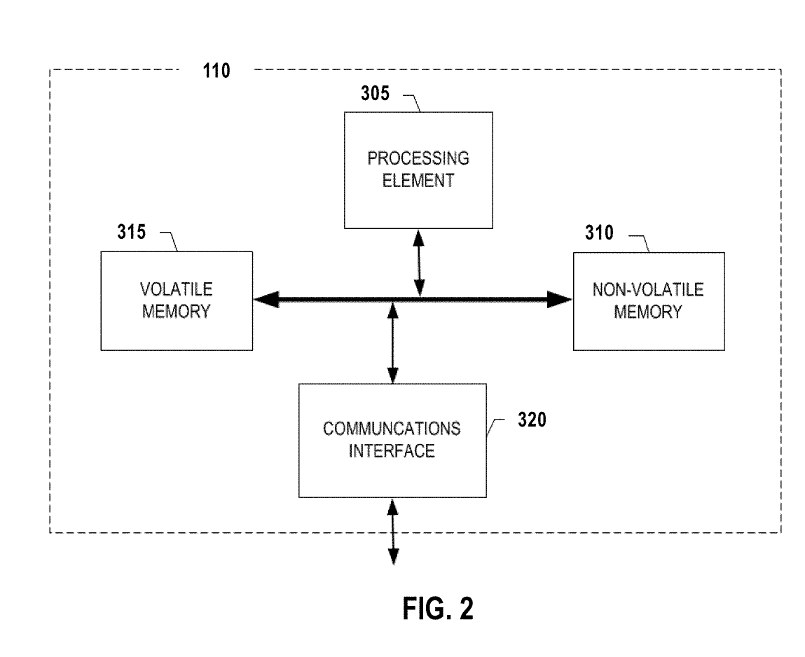

FIG. 2 provides a schematic of a central computing entity 110 according to one embodiment of the present invention. In general, the terms computing entity, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, items/devices, vehicles, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the central computing entity 110 may also include one or more communications interfaces 320 for communicating with various computing entities, such as by communicating data, content, information, and/or similar terms used herein interchangeably that can be transmitted, received, operated on, processed, displayed, stored, and/or the like. For instance, the central computing entity 110 may communicate with vehicles 100, mobile computing entities 105, and/or the like.

As shown in FIG. 2, in one embodiment, the central computing entity 110 may include or be in communication with one or more processing elements 305 (also referred to as processors, processing circuitry, and/or similar terms used herein interchangeably) that communicate with other elements within the central computing entity 110 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present invention when configured accordingly.

In one embodiment, the central computing entity 110 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 310 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the central computing entity 110 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 305. Thus, the databases, database instances, database management system entities, data, applications, programs, program modules, scripts, source code, object code, byte code, compiled code, interpreted code, machine code, executable instructions, and/or the like may be used to control certain aspects of the operation of the central computing entity 110 with the assistance of the processing element 305 and operating system.

As indicated, in one embodiment, the central computing entity 110 may also include one or more communications interfaces 320 for communicating with various computing entities, such as by communicating data, content, information, and/or similar terms used herein interchangeably that can be transmitted, received, operated on, processed, displayed, stored, and/or the like. For instance, the central computing entity 110 may communicate with computing entities or communication interfaces of the vehicle 100, mobile computing entities 105, and/or the like.

Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the central computing entity 110 may be configured to communicate via wireless external communication networks using any of a variety of protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. Although not shown, the central computing entity 110 may include or be in communication with one or more input elements, such as a keyboard input, a mouse input, a touch screen/display input, audio input, pointing device input, joystick input, keypad input, and/or the like. The central computing entity 110 may also include or be in communication with one or more output elements (not shown), such as audio output, video output, screen/display output, motion output, movement output, and/or the like.

As will be appreciated, one or more of the central computing entity's 110 components may be located remotely from other central computing entity 110 components, such as in a distributed system. Furthermore, one or more of the components may be combined and additional components performing functions described herein may be included in the central computing entity 110. Thus, the central computing entity 110 can be adapted to accommodate a variety of needs and circumstances.

c. Exemplary Mobile Computing Entity

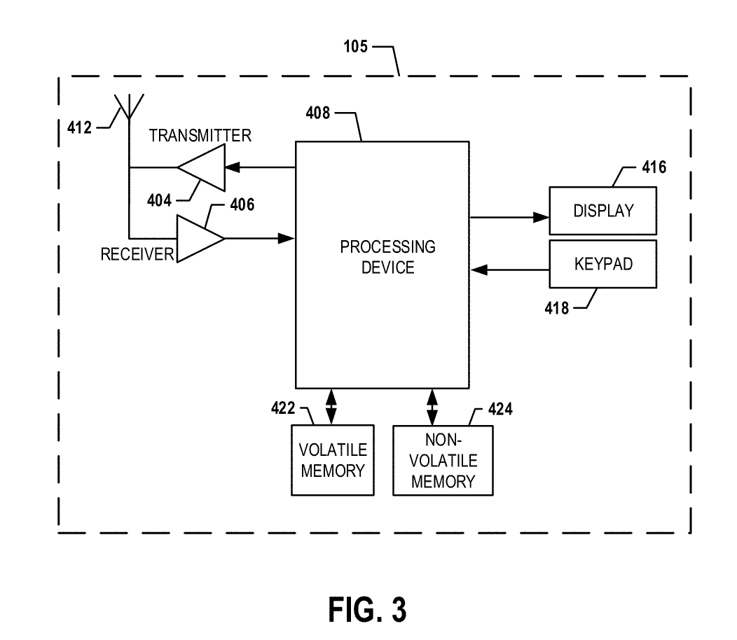

FIG. 3 provides an illustrative schematic representative of a mobile computing entity 105 that can be used in conjunction with embodiments of the present invention. As non-limiting examples, the mobile computing entities 105 may be embodied as handheld computing entities, wearable computing entities (e.g., augmented reality glasses), earpieces, haptic feedback devices, and/or the like. In one embodiment, the mobile computing entities 105 may include one or more components that are functionally similar to those of the central computing entity 110 and/or as described below. As will be recognized, mobile computing entities 105 can be operated by various parties, including operators of vehicles 100. As shown in FIG. 3, a mobile computing entity 105 can include an antenna 412, a transmitter 404 (e.g., radio), a receiver 406 (e.g., radio), and a processing element 408 that provides signals to and receives signals from the transmitter 404 and receiver 406, respectively.

The signals provided to and received from the transmitter 404 and the receiver 406, respectively, may include signaling information/data in accordance with an air interface standard of applicable wireless systems to communicate with various entities, such as vehicles 100, central computing entities 110, and/or the like. In this regard, the mobile computing entity 105 may be capable of operating with one or more air interface standards, communication protocols, modulation types, and access types. More particularly, the mobile computing entity 105 may operate in accordance with any of a number of wireless communication standards and protocols. In a particular embodiment, the mobile computing entity 105 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile computing entity 105 can communicate with various other entities using concepts such as Unstructured Supplementary Service information/data (US SD), Short Message Service (SMS), Multimedia Messaging Service (MMS), Dual-Tone Multi-Frequency Signaling (DTMF), and/or Subscriber Identity Module Dialer (SIM dialer). The mobile computing entity 105 can also download changes, add-ons, and updates, for instance, to its firmware, software (e.g., including executable instructions, applications, program modules), and operating system.

According to one embodiment, the mobile computing entity 105 may include location determining aspects, devices, modules, functionalities, and/or similar words used herein interchangeably. For example, the mobile computing entity 105 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the mobile computing entity's 105 position in connection with a variety of other systems, including cellular towers, Wi-Fi access points, and/or the like. Similarly, the mobile computing entity 105 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The mobile computing entity 105 may be configured to output data/information to a user. For example, the mobile computing entity 105 may be configured to provide data/information as audio output (e.g., via an earpiece), as visual output, as haptic feedback, and/or the like. The mobile computing entity 105 may also comprise a user interface (that can include a display 416 coupled to a processing element 408) and/or a user input interface (coupled to a processing element 408). For example, the user interface may be an application, browser, user interface, dashboard, webpage, and/or similar words used herein interchangeably executing on and/or accessible via the mobile computing entity 105 to interact with and/or cause display of information. The user input interface can comprise any of a number of devices allowing the mobile computing entity 105 to receive data, such as a keypad 418 (hard or soft), a touch display, voice/speech or motion interfaces, scanners, readers, or other input device. In embodiments including a keypad 418, the keypad 418 can include (or cause display of) the conventional numeric (0-9) and related keys (#, *), and other keys used for operating the mobile computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the mobile computing entity can collect contextual information/data as part of the telematics data.

The mobile computing entity 105 can also include volatile storage or memory 422 and/or non-volatile storage or memory 424, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the mobile computing entity 105.

In various embodiments, the mobile computing entity 105 also includes a scanner that may be utilized to interact with a surrounding physical environment to obtain external data from one or more external data sources. For example, a scanner may comprise a barcode scanner, a camera, an RFID reader, a BLE receiver, and/or the like configured to obtain data from one or more tags located in a physical environment. For example, the scanner may be configured to retrieve data from a tag once the scanner is within a transmission range of the tag (e.g., 6 inches, 1 foot, 3 feet, and/or the like). Accordingly, the mobile computing entity 105 may be configured to be moved between various tags (and between various tag transmission ranges) to retrieve data from the various tags within a physical environment.

d. Exemplary User Computing Entity

In one embodiment, the user computing entities 140 may each include one or more components that are functionally similar to those of the central computing entity 110 and/or the mobile computing entity 105. For example, in one embodiment, each of the user computing entities 140 may include: (1) a processing element that communicates with other elements via a system interface or bus; (2) a user interface; (3) transitory and non-transitory memory; and (4) a communications interface. As previously noted, the user computing entity 140 may comprise a user interface. For example, the user interface may be an application, browser, user interface, dashboard, webpage, and/or similar words used herein interchangeably executing on and/or accessible via the user computing entity 140 to interact with and/or cause display of information/data from the central computing entity 110 and/or the mobile computing entity 105, as described herein. These architectures are provided for exemplary purposes only and are not limiting to the various embodiments.

### III. Exemplary System Operation

As discussed herein, various embodiments are directed to a distributed system comprising a central computing entity 110 configured, at least in part, to schedule and/or delegate tasks among one or more mobile computing entities 105, which are configured for generating data based on interactions with their physical environment to complete the assigned tasks.

As discussed herein, tasks may comprise steps for generating specifically requested data, which may be location specific (e.g., the data must be generated by a computing entity at a particular physical location) and/or may be generated based on interactions with one or more physical items, tags, and/or the like (e.g., by scanning tags).

In various embodiments, tasks may comprise steps for retrieving data from various tags located on and/or in various objects (e.g., vehicles, fuel pumps, car wash stations, parking areas, mops, brooms, soap dispensers, and/or the like). In various embodiments, identifier tags may comprise data indicative of the object to which they are attached (e.g., a vehicle identifier, a fuel pump identifier, and/or the like). In certain embodiments, activity tags may comprise data indicative of an activity performed by an individual (e.g., washing a vehicle, waxing a vehicle, sweeping the interior of a vehicle, refueling a vehicle, repositioning a vehicle, and/or the like). Moreover, state tags may comprise data indicative of a particular state of an object (e.g., vehicle interior clean; vehicle interior dirty; vehicle fluids at desired levels; vehicle oil low; and/or the like.

As discussed herein, a tag may comprise a placard secured relative to one or more objects. The placards may comprise stickers secured relative to one or more objects; rigid and/or flexible signs secured relative to one or more objects; and/or the like. In various embodiments, a tag may comprise printed indicia secured to various objects (e.g., via a sticker, via printing directly onto the various objects, and/or the like). In various embodiments, tags may comprise bar codes, QR codes, Maxi-codes, character strings (e.g., human readable and/or machine readable), symbols, and/or the like. In such embodiments, retrieving data from various tags may comprise scanning the tags via a scanning device in communication with and/or incorporated into the mobile computing entity, and/or receiving user input indicative of the data provided via the tags.

In certain embodiments, tags may comprise electronic devices configured to transmit or otherwise communicate stored data to one or more computing entities. For example, the tags may comprise RFID tags (e.g., active and/or passive); Bluetooth beacons (e.g., BLE beacons); Wi-Fi transmitters; and/or the like. Accordingly, retrieving data from the one or more tags may comprise scanning (e.g., actively and/or passively) for electronically transmitted data from the one or more beacons, and storing the retrieved data in a memory associated with a computing entity. As discussed herein, a mobile computing entity 105 may be configured to retrieve data from a tag once the mobile computing entity 105 is within a transmission range of the tag. In various embodiments, the transmission ranges of a plurality of tags do not overlap, such that a mobile computing entity 105 may physically move between tags (and corresponding transmission ranges) to retrieve data from a plurality of tags.

In various embodiments, tags may comprise location-specific data that may be accessible while a tag is positioned at a particular physical location. Tags may thus be associated with one or more locations (e.g., geofenced areas), such that data contained within the tag may be accessible (e.g., scannable by a mobile computing entity 105) only while the tag is located at/in the associated location. Certain tags may be physically limited from moving away from/out of the associated location (e.g., a tag secured relative to a stationary fuel pump; a tag secured relative to a stationary car wash sprayer; and/or the like). However, certain tags may be movable relative to the associated location. For example, a vehicle 100 may have a vehicle identifier tag; one or more state tags (e.g., indicative of various levels of cleanliness); and/or the like. The one or more state tags may be associated with a geofenced area within a vehicle wash bay; such that the one or more state tags are only scannable while the vehicle 100 (and the associated state tags) are located within the vehicle wash bay. In various embodiments, the tags may comprise one or more mechanisms (e.g., movable mechanisms to manipulate and/or cover various tags, electronic programming within an electronic tag, and/or the like) configured to prevent scanning of the tag unless the tag is located within the associated location. In certain embodiments, data stored within the one or more tags may indicate the associated location, such that the mobile computing entity 105 may only store data from the tag if scanned while within the associated location.

In various embodiments, tasks may define a series of steps to be performed by a computing entity and/or a plurality of data types to be collected by a computing entity. For example, a task may be generated to be completed while a user of a mobile computing entity 105 refuels a vehicle. The task delegated to the mobile computing entity 105 may comprise steps for retrieving identifying data for a vehicle to be refueled (e.g., from an identifier tag located on/in the vehicle); retrieving identifying data for a fuel pump utilized (e.g., from an activity tag located on/in the fuel pump); retrieving data indicative of an amount of fuel added to the vehicle (e.g., via user input and/or from one or more monitoring devices corresponding to the fuel pump, via scanning a fuel amount activity tag located on the fuel pump, and/or the like); calculating an amount of time spent fueling (e.g., by determining a difference between a time indicated as a fueling start time and a time indicated as a fueling end time as determined by, for example scanning of various tags associated with the task); retrieving a task completion location (e.g., based on a determined location of the mobile device when the task is being completed); and/or the like.

In certain embodiments, tasks may indicate specific data to be collected (e.g., specific data of a specific data type). For example, a task may be defined as associated with a job to refuel a specific vehicle having a vehicle identifier ABC123 using a specific fuel pump having a pump identifier FUEL-3. Accordingly, the task may comprise steps for retrieving identifying data for the vehicle ABC123 (e.g., from an identifier tag located on/in the vehicle); retrieving identifying data from the fuel pump FUEL-3; retrieving data indicative of an amount of fuel added to the vehicle; calculating an amount of time spent fuel; retrieving a job location at the known location of the fuel pump FUEL-3 (e.g., within a geofenced area surrounding the fuel pump FUEL-3); and/or the like.

a. Scheduling and Delegating Tasks

In various embodiments, the central computing entity 110 may be configured to schedule and/or delegate one or more tasks to one or more mobile computing entities 105. As discussed herein, tasks may comprise steps for generating specifically requested data, which may be location specific (e.g., the data must be generated by a computing entity at a particular physical location; within a defined geofence; and/or the like) and/or may be generated based on interactions with one or more physical items, tags, and/or the like (e.g., scanning a tag with a mobile computing entity 105 located within a transmission range of the tag). In various embodiments, tasks may encompass computer processes corresponding to various physical jobs to be performed by individuals. For example, an individual may be assigned a job to refuel a vehicle, and a corresponding task for recording data confirming that the individual completed the assigned job may be assigned to a mobile computing entity 105 carried by the individual.

Tasks may be defined by corresponding task records generated, scheduled, delegated, and/or stored by the central computing entity 110. In various embodiments, the task records may be stored in a scheduling database in electronic communication with the central computing entity 110. The task records identifies the various steps to be performed for the task, the types of data to be retrieved for the task, the specific data to be retrieved for the task, an estimated time to complete the task, the location at which the task is to be completed, qualifications for mobile computing entities 105 to perform the task, and/or the like. As will be discussed in greater detail herein, once a particular task is complete, the associated task record may be updated to reflect the actual data collected and/or generated, and the updated task record may remain stored in the scheduling database.

In various embodiments, tasks may have assigned locations at which one or more portions of the task are to be completed. The assigned locations for various tasks may align and/or overlap with locations associated with various tags to be scanned while completing a task. In certain embodiments, a task may be associated with multiple locations, such as a location where the task is scheduled to begin and a location where the task is scheduled to end. For example, a task may be associated with a job for moving a particular vehicle from a first location to a second location. Accordingly, the task may be scheduled to begin at the first location, and the task may be scheduled to end at the second location. Accordingly, a corresponding task record may identify a scheduled start location (e.g., a geographical location and/or a geofenced area) and/or a scheduled end location (e.g., a geographical location and/or a geofenced area) for the task. In various embodiments, the central computing entity 110 may be configured to assign one or more locations (e.g., a scheduled start location and/or a scheduled end location) to a task record based on data received from one or more external data sources. For example, a scheduled start location for a task may be identified as the last-known location of a particular tag to be scanned to begin a task (e.g., the last known location of an identity tag, which may correspond to the last known location of the equipment to which the identity tag is secured). In various embodiments, the central computing entity 110 may thus retrieve last-known location data from one or more external data sources (e.g., a separate database in communication with the central computing entity 110; one or more mobile computing entities 105; and/or the like) and may update the generated task record to incorporate the last-known location data as a scheduled start location for a particular task.

As discussed herein, the mobile computing entity 105 may be configured to record actual start locations and/or actual end locations for various tasks (e.g., based on self-determined locations of the mobile computing entity 105) regardless of whether the locations align with the scheduled start locations and/or end locations. In such embodiments, a computing entity (e.g., mobile computing entity 105 and/or central computing entity 110) may be configured to flag the task record as indicating that the task was not completed according to assigned locations.

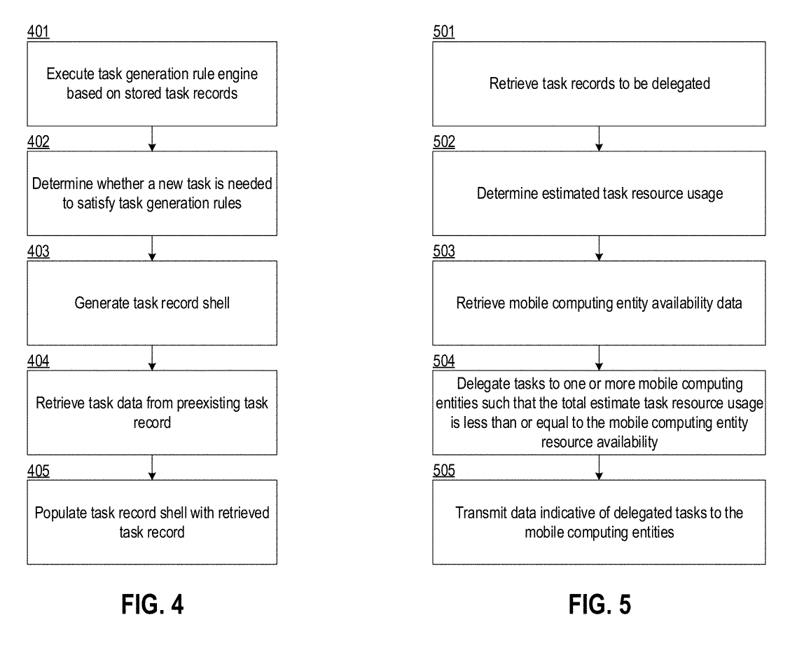

Tasks (and corresponding task records) may be generated by the central computing entity 110 automatically and/or in response to user input. In embodiments in which tasks are generated automatically, the central computing entity 110 may utilize a task generation rule engine as a portion of the task generation process, as shown in FIG. 4. The task generation rule engine may be embodied as a physically distinct computing entity, and/or as a computing module within the central computing entity 110. The task generation rule engine may be configured to access the scheduling database to monitor when various tasks are performed. The task generation rule engine may comprise one or more task generation rules stored for various task types, for various identifier tags, and/or the like. For example, the task generation rule engine may comprise one or more task generation rules for various task types corresponding to vehicle identifier ABC123. As specific examples, the task generation rule engine may comprise rules indicating a frequency that tasks for collecting data relating to fueling jobs for vehicle ABC123; for sweeping jobs for vehicle ABC123; for fluid check jobs for vehicle ABC123; and/or the like.

For example, the task generation rule engine may define a task frequency, a task trigger event, and/or the like that may be utilized to generate one or more tasks. For example, the task generation rule engine may specify that a particular task is to be performed once every 15 days; a particular task should be performed immediately following the occurrence of another task; and/or the like. In various embodiments, tasks may be generated with reference to specifically defined data (e.g., tags that must be scanned for a task), and thus tasks may be generated according to a schedule that may be specific to various defined data to be retrieved. For example, tasks associated with car wash jobs to be performed on specific vehicles may be scheduled individually for each vehicle identifier tag to be scanned during a particular task. For example, the task generation rules may define that car-wash related tasks are to be scheduled for each vehicle identifier within a defined grouping every 15 days.

In various embodiments, the task generation rule engine may be configured to monitor task records stored within the scheduling database to determine when a new task should be generated. Upon determining that a new task is needed, for example, upon determining that the most-recently performed task for a specific task type and/or a specific identifier tag occurred more than a threshold time since the present time (e.g., the previous car wash task relating to vehicle ABC123 occurred more than 7 days ago), the task generation rule engine may be configured to initialize a task generation process.

With reference to FIG. 4, which illustrates the steps of an example process for generating a task, the process may begin by executing a task generation rule engine, as shown in Block 401. Using the task generation rule engine, the central computing entity 110 may determine whether a new task is needed to satisfy applicable task generation rules stored in the task generation rule engine. The central computing entity 110 may accordingly apply the task generation rule engine with respect to stored task records (e.g., stored completed task records) to determine whether task generation rules are satisfied (e.g., task generation frequency rules).

The central computing entity 110 may constantly and/or periodically run one or more task generation rule engines with reference to stored task records (e.g., stored within the scheduling database) to determine whether the task generation rules require a new task to satisfy the existing task generation rules. Moreover, in certain embodiments, the central computing entity 110 may be configured to monitor for one or more trigger events that may indicate that a new task should be generated. For example, user input may be received indicating that a new task (and corresponding task record) should be generated.

Upon determining that a new task is needed (e.g., based on the task generation rules and/or the occurrence of one or more trigger events), the central computing entity 110 generates a new task record corresponding to the task. As indicated at Block 403 of FIG. 4, the central computing entity may generate a generic task record shell to be populated with task-specific data once retrieved. In various embodiments, the generic task record may be task-type independent, such that the central computing entity 110 need only generate a single generic task record shell type. In such embodiments, the generic task record shell may be modified based on the type of task to be completed. In other embodiments, the generic task record may be specific to a particular task type (e.g., a car wash task; a refueling task; and/or the like), but may be generic as to the identifier tag to which the task applies. In such embodiments, the central computing entity 110 may be configured to generate a plurality of generic task record shells based on a type of task to be completed.

In various embodiments, the central computing entity 110 may retrieve various aspects of the task to be performed while generating the task record from one or more sources. As shown at Block 404 of FIG. 4, the central computing entity 110 may generate and/or retrieve task data based on preexisting task records (e.g., one or more prior task records that were identified as related by the task generation rule engine). As additional examples, the central computing entity 110 may retrieve aspects of the task to be performed from the task generation rules, from prior and/or related tasks (e.g., tasks relating to the same tag), from user input, and/or the like. For example, for a new task record generated based on the application of a task generation rule indicating that new car-wash data should be collected relating to vehicle identifier ABC123, the central computing entity 110 may be configured to retrieve data from a prior car-wash data collection task stored in the scheduling database and to copy various aspects of the prior task to the new task record. For example, the central computing entity 110 may copy the vehicle identifier, the types of data to be recorded, the steps to be completed, and/or the like from the prior task record. The central computing entity 110 then populates the generic task record shell with the retrieved task-specific data to form a task record. In various embodiments, the new task record identifies the task to be performed, identifies the steps to be performed for the task, identifies the data to be retrieved for the task, and/or the like.

Moreover, in various embodiments, the central computing entity 110 may be configured to determine an estimated resource usage needed to complete the task. For example, the central computing entity 110 may be configured to determine the estimated amount of computer processing time needed to complete a task, the estimated amount of elapsed time needed to complete the task, the estimated amount of battery life needed to complete the task, and/or the like. In various embodiments, estimated resource usage may be provided based on user input, may be determined based on a historical average resource usage to complete similar tasks, and/or the like. For example, user input may specify an estimated amount of elapsed time needed to complete a task. As discussed herein, the central computing entity 110 may be configured to utilize the estimated resources needed to complete the task when delegating various tasks. For example, the central computing entity 110 may ensure that an estimated resource usage needed to complete all of the tasks delegated to a particular mobile computing entity 105 does not exceed the resource availability of a mobile computing entity 105 to complete the delegated tasks.

Upon generating the new task record, the central computing entity 110 stores the generated task record in the scheduling database. The central computing entity 110 may generate a plurality of tasks using a similar process, and may store all of the generated tasks in the scheduling database. In various embodiments, the central computing entity 110 may be configured to assign a completion date and/or a delegation date to each generated task record. For example, the completion date may identify the date by which the task is scheduled to be completed to comply with applicable task generation rules. The delegation date may be utilized to determine when a task is delegated to one or more mobile computing entities 105, as discussed herein. For example, the central computing entity 110 may, in various embodiments, generate and store a task record prior to the task record being delegated. In such embodiments, the central computing entity 110 waits until the delegation date before delegating the task to one or more mobile computing entities 105 for completion.

In various embodiments, the central computing entity 110 may delegate the one or more tasks to one or more mobile computing entities 105 for completion. The central computing entity 110 may, in certain embodiments, delegate the tasks to various mobile computing entities directly, such that the delegated tasks become directly associated with the mobile computing entity 105 hardware. Alternatively, the central computing entity 110 may be configured to delegate the one or more tasks to one or more user profiles, and each of the user profiles may be selectably associated with a particular mobile computing entity.

FIG. 5 is a flowchart providing an example process for delegating tasks to mobile computing entities 105 according to various embodiments. As shown in FIG. 5, the process may begin by retrieving task records to be delegated, as shown at Block 501. As noted herein, task records may be associated with data identifying a completion date and/or a delegation date, and accordingly the central computing entity 110 may be configured to retrieve those task records to be delegated. Moreover, as shown at Block 502, the central computing entity 110 may be configured to determine an estimated resource usage to complete the tasks to be delegated, such that the central computing entity 110 appropriately disseminates tasks among various mobile computing entities 110. Moreover, as noted at Block 503, the central computing entity 110 may be configured to retrieve resource availability data for one or more mobile computing entities 105. As discussed herein, the resource availability data may be indicative of a total amount of time available for a mobile computing entity 105 to complete tasks within a given time period (e.g., within a given day); total processor time available to complete tasks; total battery life to complete tasks; total memory to store and/or complete tasks; and/or the like. Moreover, the resource availability data may comprise qualification data indicating types of tasks that one or more mobile computing entities 105 are qualified to complete. The qualification data may be specific to a particular mobile computing entity 105 (e.g., specific to the mobile computing entity hardware), specific to a user profile associated with the mobile computing entity, and/or the like. For example, the qualification data may indicate that a particular mobile computing entity 105 is qualified to perform car-wash tasks only. Accordingly, the central computing entity 110 may be configured to delegate only car-wash tasks to the particular mobile computing entity 105.

In various embodiments, the central computing entity 110 may receive availability data corresponding to each of one or more mobile computing entities 105. The availability data may indicate the amount of time available to complete various tasks for a particular mobile computing entity. The availability data may be generated based at least in part on characteristics of the mobile computing entity (e.g., battery life) and/or the availability data may be generated based at least in part on the availability of a user associated with a particular mobile computing entity. For example, the availability data may indicate that an associated user has 7.5 hours of availability per day, and accordingly the availability data may indicate that the mobile computing entity is available to complete tasks for 7.5 hours. Because the mobile computing entity 105 may only be available for task completion while actively managed by a user, the availability of the mobile computing entity 105 to complete tasks may be limited by the availability of an associated user. In various embodiments, the availability of the associated user may be provided as a portion of a user profile, as discussed herein.

Upon receiving the availability data corresponding to each of the plurality of mobile computing entities 105, the central computing entity 110 may be configured to delegate generated tasks to the one or more mobile computing entities 105, as shown at Block 504 of FIG. 5. When delegating tasks, the central computing entity 110 assigns various tasks to each of the one or more mobile computing entities 105, and tracks the aggregate estimated resource usage to complete the tasks against the total resource availability for each of the mobile computing entities 105. The central computing entity 110 may be configured to delegate tasks such that the aggregate estimated resource usage for all tasks delegated to a particular mobile computing entity 105 does not exceed the resource availability for the mobile computing entity 105. For example, if the mobile computing entity 105 has 4 hours of availability to complete tasks during a given day, the central computing entity 110 may be configured to delegate tasks to the mobile computing entity 105 such that the aggregate estimated time to complete all of the tasks is 4 hours or less.

In various embodiments, the central computing entity 110 may utilize any of a variety of delegation algorithms while delegating tasks to the one or more mobile computing entities 105. For example, the central computing entity 110 may be configured to balance the number of tasks, estimate aggregate task completion time, and/or the like among the one or more mobile computing entities; the central computing entity 110 may be configured to completely utilize an availability of one mobile computing entity prior to beginning to assign tasks to a second mobile computing entity, and/or the like.

In various embodiments, upon determining that there is insufficient available resources to complete the tasks eligible for delegation, the central computing entity 110 may be configured to generate an alert to be transmitted to one or more users (e.g., an administrator), who may adjust the amount of available resources (e.g., by adding additional mobile computing entities 105, by adjusting the amount of available time for the mobile computing entities 105, and/or the like). Similarly, upon determining that there is excess available time for one or more mobile computing entities, the central computing entity 110 may be configured to generate an alert to be transmitted to one or more users (e.g., the administrator), who may adjust the amount of available time (e.g., by removing one or more mobile computing entities; by adjusting the amount of available time for the mobile computing entities, and/or the like).

In various embodiments, the central computing entity 110 may delegate various tasks by flagging task records with a data marker indicating which mobile computing entity 105 (and/or user profile) the task is assigned to. In various embodiments, the central computing entity 110 may additionally transmit the task records to the delegated mobile computing entity in real-time, as the central computing entity 110 delegates the corresponding tasks, or the central computing entity 110 may transmit the task records to the delegated mobile computing entities in bulk after all tasks have been delegated to respective mobile computing entities.

In various embodiments, tasks may be delegated based at least in part on the availability data for each of the plurality of the mobile computing entities 105 and/or various task specialties for the one or more mobile computing entities. In various embodiments, the mobile computing entities 105 may be assigned corresponding task specialties indicating the types of tasks that the particular mobile computing entity is eligible to perform. For example, a particular mobile computing entity 105 may be assigned a “fueling” task specialty, indicating that the particular mobile computing entity 105 is eligible to perform fueling tasks (e.g., generating and storing data indicating that a vehicle has been refueled). In such embodiments, the central computing entity 110 may be configured to assign fueling tasks to the particular mobile computing entity 105. In various embodiments, a mobile computing entity 105 may be associated with a plurality of task specialties, indicating that the mobile computing entity 105 is eligible to perform any of the various tasks corresponding to the assigned task specialties. Moreover, in various embodiments, the task specialties may be assigned to a user profile, which may be selectively attributed to a particular mobile computing entity 105.

Upon delegation, the various task records may be stored within the memory of the delegated mobile computing entity 105 and/or the task records may be accessible to the mobile computing entity 105 (e.g., via a network). As discussed herein, the mobile computing entity 105 assigned to a particular task may be configured to update the assigned task record with data generated to complete the task.

In various embodiments, the central computing entity 110 may be configured to generate and/or delegate tasks for a plurality of physically separate and distinct facilities. Each facility may have associated tags (e.g., identifier tags, activity tags, and/or state tags); associated mobile computing entities 105; associated user profiles; and/or the like. For example, a first facility may be located in Atlanta, Ga. and may be associated with a first set of mobile computing entities 105 configured to perform various tasks and a second facility may be located in Los Angeles, Calif. and may be associated with a second set of mobile computing entities 105 configured to perform various tasks. Accordingly, the central computing entity 110 may be configured to generate and delegate tasks separately for each facility, such that only those mobile computing entities 105, user profiles, and/or the like are delegated tasks associated with a common facility.

b. Completing Tasks

As discussed herein, tasks may be completed by one or more mobile computing entities 105, for example by retrieving and/or generated data based on interactions between the mobile computing entity 105 and the physical environment surrounding the mobile computing entity 105 (e.g., interactions with various tags, placards, and/or the like). For example, the mobile computing entity 105 may be configured to retrieve data (e.g., via scanning) from one or more tags (e.g., identifier tags, activity tags, state tags, and/or the like) to update one or more task records corresponding to tasks assigned to the mobile computing entity 105.

As discussed herein, the tasks to be completed by the mobile computing entity 105 may correspond to jobs to be completed by an individual associated with (e.g., carrying) the mobile computing entity 105. For example, the individual may be assigned a job to wash a particular vehicle 100, and the associated mobile computing entity 105 may be delegated a task to generate and/or retrieve data before, during, and/or after the individual completes the assigned car wash job.

In various embodiments, the tasks assigned to the mobile computing entity 105 may be instructive as to the jobs assigned to the associated individual. Because each task assigned to the mobile computing entity 105 may be associated with a particular job assigned to the associated individual, the individual may utilize data indicative of tasks assigned to the mobile computing entity 105 to determine which jobs are assigned to the individual. Accordingly, the mobile computing entity 105 may be configured to generate an interactive user interface (e.g., via a display associated with the mobile computing entity 105) configured to provide data indicative of tasks assigned to the mobile computing entity 105. For example, the mobile computing entity 105 may be configured to provide a display indicative of the number of tasks assigned to the mobile computing entity 105. The display may segregate the assigned tasks by task type, such that the display is indicative of the number of tasks assigned for each task type (e.g., the number of cash-wash tasks, the number of refueling tasks, and/or the like). In various embodiments, the display may be interactive, such that selecting a particular task type may provide an expanded display of identifier tags for which the particular task type should be performed (e.g., car-wash tasks assigned for vehicle identifiers: ABC123; DEF456; GHI789).

In various embodiments, the mobile computing entity 105 may be configured to store data identifying the individual associated with the mobile computing entity 105. In various embodiments, such identifying data is stored as a user profile. The user profile may comprise data identifying the individual, such as a name, a user name, an employee number, and/or the like. In various embodiments, the user profile may comprise additional information associated with the individual, such as contact information for the individual (e.g., phone number, email address, and/or the like), residential information, work location information, job specialty information (e.g., data identifying one or more job types that the individual is authorized to complete), and/or the like. In various embodiments, the user profile may be stored in association with the central computing entity 110, and may be selectively accessed via a mobile computing entity by providing identifying information (e.g., a username) and/or a password. Upon providing the identifying information corresponding to a user profile, the mobile computing entity 105 may be configured to retrieve data corresponding to the mobile computing entity 105 and to associate the user profile with the mobile computing entity 105 until the individual signs out of the user profile.

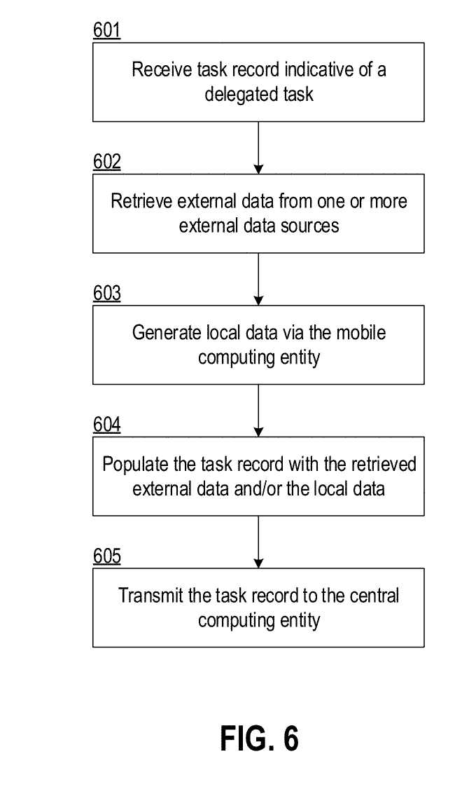

FIG. 6 provides a flowchart of an example process for completing various tasks. As shown in FIG. 6, the mobile computing entity 105 may be configured to receive a task record indicative of a delegated task to be performed by the mobile computing entity 105, as shown at Block 601. As discussed herein, the mobile computing entity 105 may receive a plurality of task records indicative of a plurality of tasks to be performed by the mobile computing entity 105.

To complete various tasks delegated to a mobile computing entity 105, the mobile computing entity 105 may be configured to retrieve data from one or more external data sources (e.g., by scanning one or more tags in a physical environment) and/or the mobile computing entity 105 may be configured to generate local data for the task, as shown at Block 602-603 of FIG. 6. For example, the mobile computing entity 105 may be configured to generate local data such as location data indicative of the current location of the mobile computing entity 105 (e.g., the current location of the mobile computing entity when the mobile computing entity scans a tag); time data indicative of the time that a tag was scanned; identity data indicative of the identity of the mobile computing entity 105 and/or the identity of a user profile corresponding to the mobile computing entity 105; and/or the like. Because the information to be retrieved while completing tasks is available at disparate physical locations in a physical environment (e.g., at various tags secured relative to various objects), the mobile computing entities 105 may be moved between various physical locations to collect the requisite data (e.g., via scanning one or more tags) to be provided to the central computing entity 110 to complete delegated tasks. In various embodiments, a single task may require the collection of data from tags at discrete and non-overlapping locations (e.g., by scanning a first tag in a first geographical area and scanning a second tag in a second geographical area that does not overlap the first geographical area). Rather than utilizing non-location specific user input offering indirect evidence that a particular task has been performed, for example, provided by an individual after completing an assigned job, utilizing mobile computing entities 105 to collect location-specific data that is directly utilized to complete various tasks ensures that accurate and precise data is recorded that is indicative of the actual task completed. Thus, accurate and precise summary statistics, such as statistics indicative of when a task was completed, which mobile computing entity completed the task, how the task was completed, and/or the like may be determined based on the recorded data.

As noted herein, task records may indicate that a task is to be started at a first location and ended at a second location. Accordingly, the mobile computing entity 105 may be configured to generate location data at various times during the completion of a task. Moreover, in various embodiments, the mobile computing entity 105 may be configured to compare the actual determined location where a tag is scanned against one or more scheduled locations identified in the task record to determine whether the task is completed at the proper location. Upon determining that the task has not been completed at an appropriate location, the mobile computing entity 105 may be configured to generate and store a flag with the task record indicating that the task was not completed at the appropriate location. For example, for a vehicle-move task associated with a job to move a vehicle to a particular location, the mobile computing entity 105 may be configured to determine whether the task was completed at the assigned location (corresponding to the location where the vehicle was ultimately parked). Upon determining that the task was not completed at the appropriate location (indicating that the vehicle was parked at an incorrect location) the mobile computing entity 105 may be configured to flag the task record as indicating that the task was not completed at the appropriate location.

Upon retrieving data to be provided for a task, the mobile computing entity 105 may populate the corresponding task record with the retrieved and/or generated data, as shown at Block 604.

In various embodiments, the mobile computing entities 105 may be configured to complete tasks selected by one or more criteria. For example, the mobile computing entities 105 may be configured to complete tasks in a defined order (e.g., complete Task 1 prior to completing Task 2); the mobile computing entities 105 may be configured to complete tasks as the tasks are selected (e.g., via user input received by the mobile computing entities 105), and/or the like. In certain embodiments, the mobile computing entities 105 may be configured to automatically select a task to complete, for example, based on received and/or generated data. For example, a mobile computing entity 105 may identify one or more tasks corresponding to a particular tag upon receipt of data associated with the tag. As a specific example, if a mobile computing entity 105 has been assigned a refueling task associated with a vehicle identifier tag ABC123, the mobile computing entity 105 may automatically select and begin completing the corresponding refueling task upon receipt of tag data corresponding to the vehicle identifier tag ABC123. As yet another example, upon determining that a refueling task is delegated to the mobile computing entity 105, the mobile computing entity 105 may be configured to automatically select and begin completing the refueling task upon determining that the mobile computing entity is located proximate a fuel pump (e.g., within a defined geofence surrounding the fuel pump).

In various embodiments, completing a task may comprise steps for retrieving and/or generating data for the task, and/or populating various data entry portions of a task record with the retrieved and/or generated data. Accordingly, the mobile computing entity 105 may be configured to interpret one or more tasks as one or more inquiries requesting specific data types. As discussed herein, various tasks may request data retrieved (e.g., scanned) from one or more tags (e.g., vehicle tags, object tags, activity tags, and/or the like); data indicative of a start time for the task (e.g., generated by the mobile computing entity when a first tag data is retrieved for the task); data indicative of an end time for the task (e.g., generated by the mobile computing entity when a last tag data is retrieved for the task); data indicative of a duration of a task (e.g., generated by the mobile computing entity based on a determined start time and a determined end time for the task); data indicative of one or more activity tags scanned by the mobile computing entity (e.g., retrieved by the mobile computing entity from one or more activity tags); data indicative of one or more equipment tags scanned by the mobile computing entity 105 (e.g., retrieved by the mobile computing entity from one or more vehicle tags and/or object tags); data indicative of a location where the task was completed (e.g., generated by the mobile computing entity 105 based on a self-determined location of the mobile computing entity when the task was completed); and/or the like.

In various embodiments, the mobile computing entity 105 transmits the generated and/or retrieved data (e.g., as a portion of a completed task record) to the central computing entity 110 to complete the task, as shown at Block 605 of FIG. 6. In certain embodiments, the mobile computing entity 105 may be configured to transmit the data as an updated task record, including all of the data retrieved and/or generated by the mobile computing entity 105 for the task. In such embodiments, the mobile computing entity 105 may be configured to update a task record, and to transmit the updated task record to the central computing entity 110. In various embodiments, the mobile computing entity 105 may be configured to transmit generated and/or retrieved data for a task in real-time, as the data is generated and/or retrieved. In embodiments according to the latter configuration, the central computing entity 110 may be configured to update the task records as relevant data is received from the mobile computing entity.

In various embodiments, the mobile computing entity 105 may be configured to generate new task records corresponding to previously undelegated tasks. For example, upon receipt of data that does not correspond to a task delegated to the mobile computing entity 105, the mobile computing entity 105 may be configured to generate a new task record to be associated with the collected data. In such embodiments, the mobile computing entity 105 may be configured to match the collected data with a particular task type, and to generate a new task record matching the selected particular task type. For example, a mobile computing entity 105 may receive data from an activity tag for checking fluids on a particular vehicle. The mobile computing entity 105 may determine that the received data does not correspond to a task delegated to the mobile computing entity 105, and the mobile computing entity 105 may generate a new task record corresponding to a task for checking vehicle fluids. As an example, an individual associated with a mobile computing entity 105 may determine that a particular vehicle's fluids should be checked, even if such a job is not assigned to the individual. The individual may proceed to utilize the mobile computing entity 105 to scan an activity tag associated with a fluid-check task, and may then check the fluid levels for the vehicle. The mobile computing entity 105 may thus generate a task record corresponding to a fluid check task such that generated data corresponding to the collected data may be recorded in the scheduling database.

c. Summarizing Updated Task Records

Upon receipt of updated task records indicative of tasks completed by various mobile computing entities 105, the central computing entity 110 may be configured to generate summary data indicative of various attributes of completed tasks. For example, the central computing entity 110 may be configured to determine an average amount of time to complete various tasks (e.g., for a particular task type, for a particular mobile computing entity, for a particular day, and/or the like).

The central computing entity 110 may be configured to execute one or more computer processing steps for querying the scheduling database to retrieve data from one or more completed task records to generate one or more summary data records. For example, the central computing entity 110 may be configured to execute one or more processing steps for retrieving data indicative of the elapsed time to complete one or more tasks, as stored in related task records. In various embodiments, the central computing entity 110 may be configured to utilize a data filter while retrieving data from the various task records and/or while executing the various processing steps to cabin the analysis to specific task records. For example, the central computing entity 110 may be configured to retrieve data from one or more task records completed during a particular time period, completed by a particular mobile computing entity 105, completed at a particular location (e.g., within a geofence surrounding a particular facility), completed by one or more mobile computing entities 105 associated with a particular user profile, and/or the like.

As noted herein, the central computing entity 110 may be configured to update stored data indicative of an estimated time to complete various tasks based on completed task records. For example, the estimated time to complete a particular task type may be determined based at least in part on the average time to complete the task, as determined based at least in part on completed task records.

As yet other examples, the central computing entity 110 may generate summary data records indicative of the total amount of fuel indicated as provided to a particular vehicle 100 during a particular time period (e.g., a week, a day, a month, and/or the like); the total time spent completing tasks by a particular mobile computing entity 105 during a particular time period (e.g., a week, a day, a month, and/or the like); and/or the like.

Moreover, in various embodiments, the central computing entity 110 may be configured to compile data indicative of tasks completed having common attributes. For example, the central computing entity 110 may be configured to compile tasks completed by a particular mobile computing entity 110 over a particular time period (e.g., a day, a week, and/or the like). The central computing entity 110 may be configured to review the compiled data and to organize the compiled data. For example, the central computing entity 110 may be configured to organize the compiled data in chronological order, thereby providing a record of the tasks completed by the mobile computing entity. In various embodiments, the central computing entity may be configured to compare the elapsed time for the mobile computing entity to complete various tasks against an estimated time for the mobile computing entity to complete those tasks. In various embodiments, the central computing entity 110 may be configured to flag those completed tasks for which the elapsed time to complete was greater than the estimated time to complete those tasks.

The central computing entity 110 may be configured to generate a graphical display including the compiled data for the one or more mobile computing entities, for example, by presenting the data as a Gantt chart. In various embodiments, the generated graphical display may visually distinguish between various completed tasks that satisfy one or more criteria. For example, tasks flagged as taking longer than an estimated time to complete may be distinguished from those tasks completed within an estimated time to complete. For example, tasks taking longer than an estimated time to complete may be shown in a first color in a generated Gantt chart, and tasks taking less than or equal to an estimated amount of time may be shown in a second color in the generated Gantt chart.

d. Example Implementation

In various embodiments, the distributed task processing system may be utilized to track jobs performed by individuals (e.g., employees) within a physical environment. The various jobs to be performed by the individuals are associated with various pieces of equipment each having corresponding identifier tags, object tags, and/or activity tags. For example, vehicles 100 to be washed, refueled, cleaned, and/or inspected may have a corresponding vehicle identifier tag, as well as one or more activity tags indicative of tasks to be performed on the vehicles. Moreover, other equipment, such as fuel pumps, car wash stations, cleaning supplies, and/or the like may be associated with additional identifier tags and/or activity tags that may be utilized to specify which equipment is used during a job and/or to indicate what activities are performed during a job.

In such embodiments, the individuals may each carry an associated mobile computing entity 105 while completing the various jobs. In certain embodiments, the mobile computing entity 105 may be configured to present a graphical display to the individual providing data indicative of one or more jobs to be performed by the individual, audio output (e.g., via an earpiece) to the individual providing data indicative of one or more jobs to be performed by the individual, haptic feedback (e.g., vibratory feedback) to the individual providing signals indicative of one or more jobs to be performed by the individual, and/or the like.

Moreover, the mobile computing entities 105 may be assigned one or more tasks corresponding to the jobs assigned to the individual. In various embodiments, the tasks may comprise processing steps to be performed by the mobile computing entity 105 to retrieve and/or generate data that may be utilized to track the individual's completion of various jobs. For example, a task may comprise processing steps for retrieving data from one or more tags corresponding to equipment utilized to complete a particular job. Moreover, the mobile computing entity 105 may be configured to generate additional data to be utilized to track the completion of an associated job, such as data indicative of when a job was started by an individual (e.g., based on when one or more tags were first scanned by the mobile computing entity), data indicative of when a job was finished by an individual (e.g., based on when one or more tags are scanned by the mobile computing entity), and/or the like. Thus, in various embodiments, the mobile computing entity 105 may be configured to complete a particular task in parallel with a job completed by an associated individual.

As a specific example, an individual may be assigned a job to clean vehicle ABC123. The mobile computing entity 105 associated with the individual is therefore assigned a corresponding task to generate a completed task record comprising specific data collected while the individual cleans the vehicle 100. Accordingly, when the individual arrives at the vehicle 100 to be cleaned, the mobile computing entity 105 may retrieve vehicle identifier data from a tag located on and/or in the vehicle 100. The mobile computing entity 105 may add the retrieved data to a task record corresponding to the assigned task, may generate start time data indicative of the time at which the vehicle identifier data was retrieved, may generate start location data indicative of the location of the mobile computing entity 105 when the vehicle identifier data was retrieved, and/or the mobile computing entity 105 may add the generated start time data and/or start location data to the task record.

As the individual begins cleaning the vehicle 100, the individual may utilize the mobile computing entity 105 to capture data from a state tag and/or an activity tag indicative of one or more car-wash activities to be performed during the job. For example, the mobile computing entity 105 may capture data from a state tag indicating the interior of the vehicle is dirty, and an activity tag indicating that the individual is sweeping the interior of the vehicle 100. The mobile computing entity 105 may then update the task record to reflect the data captured from the state tag and/or the activity tag.

Once the individual has completed the cleaning task, the individual may scan the activity tag and/or the vehicle identifier tag with the mobile computing entity 105 to indicate that the individual has completed the cleaning task. The mobile computing entity 105 may generate completion time data indicative of the time at which the task was completed, completion location data indicative of the location at which the task was completed, and/or the mobile computing entity 105 may add the generated completion time data and/or completion location data to the task record. The mobile computing entity 105 may be configured to transmit the completed task record corresponding to the car wash job to the central computing entity for storage.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A distributed computing task processor comprising:
a central computing entity configured to:
generate one or more task records corresponding to one or more computing tasks, wherein each task record identifies one or more data types to be provided to complete the computing task; and
delegate the one or more computing tasks to one or more mobile computing entities in electronic communication with the central computing entity;
one or more mobile computing entities each configured to:
receive one or more task records corresponding to computing tasks delegated to the mobile computing entity;
retrieve, from external data sources, external task data identified by the task record;
generate local task data identified by the task record;
update one or more task records to include at least a portion of the external task data and the local task data to complete at least a portion of the task; and
transmit at least a portion of the one or more updated task records to the central computing entity.

2. The distributed computing task processor of claim 1, wherein the central computing entity is configured to generate one or more task records based at least in part on an existing task record stored in association with the central computing entity and a task generation criteria.

3. The distributed computing task processor of claim 2, wherein the task generation criteria specifies a task generation frequency.

4. The distributed computing task processor of claim 3, wherein the task generation frequency is defined for a particular task type.

5. The distributed computing task processor of claim 1, wherein the one or more mobile computing entities are selectably associated with a user profile, and
wherein delegating the one or more computing tasks comprises delegating the one or more computing tasks to a user profile.

6. The distributed computing task process of claim 1, wherein delegating one or more computing tasks comprises:
determining an estimated resource intensity for each of one or more computing tasks;
determining a resource availability for each of one or more mobile computing entities;
delegating one or more tasks to one or more mobile computing entities such that the overall estimated resource intensity of tasks delegated to a particular mobile computing entity is equal to or less than the resource availability for the mobile computing entity.

7. The distributed computing task process of claim 6, wherein:
the estimated resource intensity for a task is the estimated amount of time to complete the task; and
the resource availability for a mobile computing entity is the amount of time available for the mobile computing entity to complete one or more tasks.

8. The distributed computing task processor of claim 1, wherein retrieving external task data comprises scanning an external data source.

9. The distributed computing task processor of claim 8, wherein scanning an external data source comprises wirelessly retrieving data from an external data source emitter.

10. The distributed computing task processor of claim 1, wherein generating local task data comprises generating location data indicative of a current location of the mobile computing entity.

11. The distributed computing task processor of claim 1, wherein generating local task data comprises generating time data indicative of a current time.

12. The distributed computing task processor of claim 1, wherein the central computing entity is further configured to:
store at least a portion of the updated task records; and
generate one or more graphical user interfaces providing a graphical display of at least a portion of the updated task records.

13. A method for processing one or more computing tasks, the method comprising steps for:
generating, via a central computing entity, one or more task records corresponding to one or more computing tasks, wherein each task record identifies one or more data types to be provided to complete the computing task;
delegating, via the central computing entity, the one or more computing tasks to one or more mobile computing entities in electronic communication with the central computing entity;
retrieving, via a mobile computing entity and from external data sources, external task data identified by the task record;
generating, via the mobile computing entity, local task data identified by the task record; and
updating, via the mobile computing entity, one or more task records to include at least a portion of the external task data and the local task data to complete at least a portion of the task.

14. The method for processing one or more computing tasks of claim 13, wherein generating one or more task records comprises generating the one or more task records based at least in part on an existing task record stored in association with the central computing entity and a task generation criteria.

15. The method for processing one or more computing tasks of claim 13, wherein delegating one or more computing tasks comprises:
determining an estimated resource intensity for each of one or more computing tasks;
determining a resource availability for each of one or more mobile computing entities;
delegating one or more tasks to one or more mobile computing entities such that the overall estimated resource intensity of tasks delegated to a particular mobile computing entity is equal to or less than the resource availability for the mobile computing entity

16. The method for processing one or more computing tasks of claim 13, wherein retrieving external task data comprises scanning an external data source.

17. The method for processing one or more computing tasks of claim 16, wherein scanning an external data source comprises wirelessly retrieving data from an external data source emitter.

18. The method for processing one or more computing tasks of claim 13, wherein generating local task data comprises generating location data indicative of a current location of the mobile computing entity.

19. The method for processing one or more computing tasks of claim 13, wherein generating local task data comprises generating time data indicative of a current time.

20. The method for processing one or more computing tasks of claim 13, further comprising steps for:
storing at least a portion of the updated task records; and
generating one or more graphical user interfaces providing a graphical display of at least a portion of the updated task records.
